(19) United States
(12) Patent Application Publication
(10) Pub. No.: US 2023/0364651 A1
(43) Pub. Date: Nov. 16, 2023

(54) OBJECT RECOGNITION DEVICE AND OBJECT PROCESSING APPARATUS

(71) Applicant: PFU LIMITED, Ishikawa (JP)

(72) Inventors: Masanobu HONGO, Ishikawa (JP); Jian Li, Ishikawa (JP)

(21) Appl. No.: 18/226,080

(22) Filed: Jul. 25, 2023

Related U.S. Application Data
(63) Continuation of application No. PCT/JP21/28845, filed on Aug. 3, 2021.

(30) Foreign Application Priority Data
Jan. 27, 2021 (JP) 2021-010992

(51) Int. Cl. B07C 5/342; G06T 7/70; G06V 20/50; H04N 23/56; H04N 23/74; B07C 5/34

(52) U.S. Cl. CPC B07C 5/3422; G06T 7/70; G06V 20/50; H04N 23/56; H04N 23/74; B07C 5/3408; B07C 2501/0054

(57) ABSTRACT

An object recognition device includes an illuminator configured to illuminate an object, an imager configured to generate an image of the object such that overexposure occurs in the image, and circuitry configured to calculate a position of the object based on the image.

### CROSS-REFERENCE TO RELATED APPLICATION

This application is a continuation of PCT International Application No. PCT/JP2021/028845 filed on Aug. 3, 2021 which claims the benefit of priority from Japanese Patent Application No. 2021-010992 filed on Jan. 27, 2021, the entire contents of which are incorporated herein by reference.

### FIELD

The embodiments discussed herein are related to an object recognition device and an object processing apparatus.

### BACKGROUND

A recyclable waste auto-segregation device is known that segregates recyclable waste, which is represented by glass bottles and plastic bottles, according to the material. A recyclable waste auto-segregation device includes a camera that captures an image of the recyclable waste; an image processing device that determines the quality of material and the position of the recyclable waste based on the image; and a robot that moves the recyclable waste of a predetermined material to a predetermined position.

In the picture of the recyclable waste in an image in which the recyclable waste is captured, if the recyclable waste has a film pasted onto its surface or has an image such as characters, an illustration, or a photograph printed onto its surface, then sometimes such details appear in the picture. Moreover, if the recyclable waste is made of a light transmissive material, then sometimes the background behind the recyclable waste also appears due to the light passing through the recyclable waste. In an image recognition device, if such a distracting picture appears in the picture in which the recyclable waste is captured, then the picture of the recyclable waste cannot be appropriately extracted from the image, and the position of the recyclable waste may not be appropriately calculated. If the position of the recyclable waste is not appropriately calculated, then a recyclable waste auto-segregation device cannot appropriately segregate the recyclable waste.

### SUMMARY

According to an aspect of an embodiment, an object recognition device includes an illuminator configured to illuminate an object, an imager configured to generate an image of the object such that overexposure occurs in the image, and circuitry configured to calculate a position of the object based on the image. According to an aspect of an embodiment, an object processing apparatus includes a remover configured to remove an object, a driver configured to move the remover, an illuminator configured to illuminate the object, an imager configured to take an image of the object such that overexposure occurs in the image, and circuitry configured to calculate a position of the object based on the image and control the driver based on the position such that the remover removes the object.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a perspective view of a recyclable waste auto-segregation device in which an object processing apparatus is installed, according to an embodiment of the present disclosure;

FIG. 2 is a cross-sectional view of an opto-electronic unit, according to an embodiment of the present disclosure;

FIG. 3 is a block diagram illustrating a control device, according to an embodiment of the present disclosure;

FIG. 4 is a flowchart for describing the operation performed by a control device for controlling a robot unit and an opto-electronic unit, according to an embodiment of the present disclosure;

FIG. 5 is a diagram illustrating an image of a photographic subject as captured a camera, according to an embodiment of the present disclosure;

FIG. 6 is a cross-sectional view of an illumination device of an object recognition device, according to a second embodiment of the present disclosure; and

FIG. 7 is a cross-sectional view of a domed housing and an illumination device of an object recognition device, according to a third embodiment of the present disclosure.

### DESCRIPTION OF EMBODIMENTS

Preferred embodiments of the disclosure will be described with reference to accompanying drawings. Exemplary embodiments of an object recognition device and an object processing apparatus according to the application concerned are described below with reference to the drawings. However, the technology disclosed herein is not limited by the description given below. Moreover, in the following description, identical constituent elements are referred to by the same reference numerals, and their description is not given repeatedly.

### First Embodiment

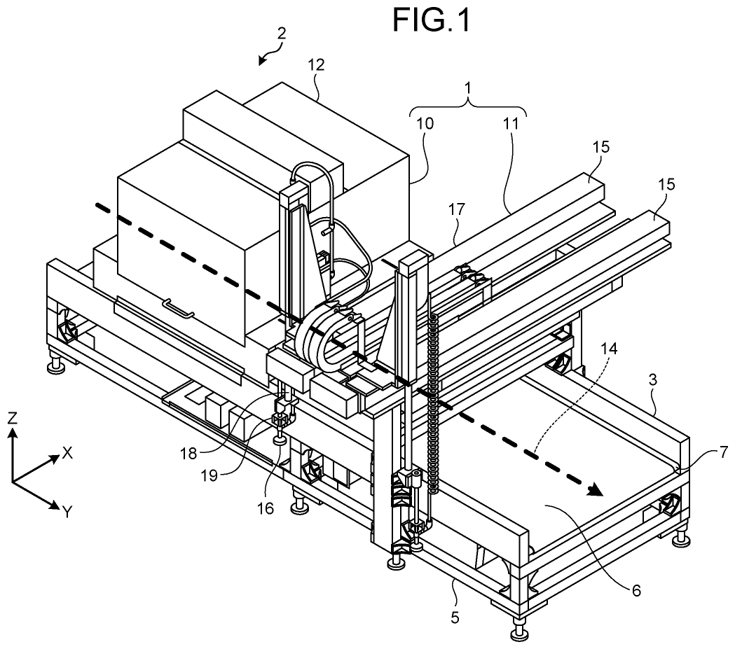

As illustrated in FIG. 1, an object processing apparatus 1 according to a first embodiment is installed in a recyclable waste auto-segregation device 2. FIG. 1 is a perspective view of the recyclable waste auto-segregation device 2 in which the object processing apparatus 1 according to the first embodiment is installed. The recyclable waste auto-segregation device 2 includes the object processing apparatus 1 and a carrier device 3. The carrier device 3 is made of, what is called, a belt conveyer that includes a belt conveyer frame 5, a belt 6, and a plurality of fixed pulleys 7; and also includes a belt driving device (not illustrated). The belt conveyer frame 5 is mounted on the same mounting surface on which the recyclable waste auto-segregation device 2 is installed. The belt 6 is made of a flexible material and is formed in a looped shape.

The fixed pulleys 7 are formed in a columnar shape, and are placed along the directions of a plurality of rotation axes. Each rotation axis is parallel to the X-axis, which is parallel to the plane along which the mounting surface is formed; and overlaps with other planes parallel to the plane along which the mounting surface is formed. The fixed pulleys 7 are supported by the belt conveyer frame 5 in a rotatable manner around the corresponding rotation axes. The belt 6 is wound around the fixed pulleys 7; is placed to run along some other plane that is parallel to the plane along which the mounting surface is formed; and is movably supported by the belt conveyer frame 5. The belt driving device rotates the fixed pulleys 7 in such a way that an object placed on the belt 6 moves parallel to the Y-axis. The Y-axis is parallel to the plane along which the mounting surface is formed, and is perpendicular to the X-axis.

The object processing apparatus 1 includes an object recognition device 10 and a robot unit 11 according to the first embodiment. The object recognition device 10 includes an opto-electronic unit 12 that is placed in the upper part of some portion of the belt 6. The robot unit 11 is placed more on the downstream side of a carrier direction 14 as compared to the object recognition device 10, and is placed in the upper part of some other portion of the belt 6. The carrier direction 14 is parallel to the Y-axis.

The robot unit 11 includes a plurality of picking robots 15 and includes a suction pump (not illustrated). A picking robot of a plurality of picking robots 15 includes a suction pad 16, an X-axis actuator 17, a Z-axis actuator 18, and a holding sensor 19; as well as includes a dumping case (not illustrated) and a solenoid valve (not illustrated). The dumping case is placed beside the carrier device 3 on the mounting surface. The suction pad 16 is supported by the belt conveyer frame 5 via the X-axis actuator 17 and the Z-axis actuator 18 to be translatable parallel to the X-axis or the Z-axis. The Z-axis is perpendicular to the plane along which the mounting surface is formed, that is, is perpendicular to the X-axis and the Y-axis. The motion range of the suction pad 16 includes the region on the upper side of the dumping case and includes the region on the upper side of some portion of the belt 6. Of the suction pad 16, the undersurface opposite to the mounting surface has an air inlet formed thereon.

The suction pump is connected to the suction pad 16 via a pipe (not illustrated), and sucks the air through the air inlet of the suction pad 16. The solenoid valve is placed midway through the pipe that connects the suction pad 16 and the suction pump. When opened, the solenoid valve connects the suction pad 16 to the suction pump in such a way that the air gets sucked through the air inlet of the suction pad 16. On the other hand, when closed, the solenoid valve shuts the connection between the suction pad 16 and the suction pump so that the air is not sucked through the air inlet of the suction pad 16.

The X-axis actuator 17 moves the suction pad 16 in the direction parallel to the X-axis. The Z-axis actuator 18 moves the suction pad 16 in the direction parallel to the Z-axis. The holding sensor 19 detects whether or not an object is held by the suction pad 16. Another picking robot from among a plurality of picking robots 15 is formed in an identical manner to the picking robot. That is, another picking robot also includes a suction pad, an X-axis actuator, a Z-axis actuator, a holding sensor, a dumping case, and a solenoid valve.

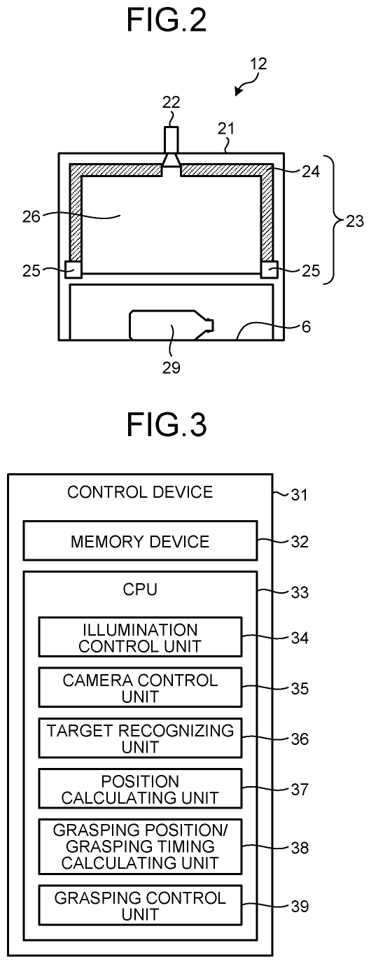

FIG. 2 is a cross-sectional view of the opto-electronic unit 12. The opto-electronic unit 12 includes a housing 21, a camera 22, and an illumination device 23. The housing 21 is made of non-transmissive material and has a box shape. The housing 21 has an internal space 26 formed therein. The housing 21 is placed on the upper side of the belt 6 in such a way that some portion of the belt 6 is present within the internal space 26 of the housing 21. Moreover, the housing 21 is fixed to the belt conveyer frame 5 of the carrier device 3. The housing 21 shields the outside light and prevents it from entering the internal space 26 of the housing 21. The housing 21 has an inlet and an outlet formed thereon. The inlet is formed in the upstream portion of the housing 21 in the carrier direction 14, and the internal space 26 is linked to the outside of the housing 21 via the inlet. The outlet is formed in the downstream portion of the housing 21 in the carrier direction 14, and the internal space 26 is linked to the outside of the housing 21 via the outlet.

The camera 22 is placed on the upper side of the housing 21. The camera 22 is fixed to the housing 21, that is, is fixed to the belt conveyer frame 5 via the housing 21. The camera 22 is, what is called, a digital camera, and takes an image for capturing a photographic subject 29 placed in that portion of the belt 6 which is present within the internal space 26. An image has a plurality of pixels paved therein. The pixels are associated to a plurality of sets of color information. Each set of color information indicates, for example, a red gradation value, a green gradation value, and a blue gradation value.

The illumination device 23 includes a reflecting member 24 and a plurality of light sources 25. The reflecting member 24 covers roughly the entire internal surface of the housing 21 that faces the internal space 26; and is placed to enclose the camera 22, that is, is placed to enclose the point of view of the image taken by the camera 22. The reflecting member 24 causes diffused reflection of the light falling thereon. The light sources 25 are placed on the inside of the housing 21 and on the lower side close to the belt 6. The light sources 25 emit a light onto the reflecting member 24.

The object recognition device 10 further includes a control device 31 as illustrated in FIG. 3. FIG. 3 is a block diagram illustrating the control device 31. The control device 31 is a computer that includes a memory device 32 and a central processing unit (CPU) 33. The memory device 32 is used to record a computer program to be installed in the control device 31, and to record the information to be used by the CPU 33. Examples of the memory device 32 include a memory such as a random access memory (RAM) or a read only memory (ROM); a fixed disk device such as a hard disk; and a solid state drive (SSD).

The CPU 33 executes the computer program installed in the control device 31 and accordingly performs information processing; controls the memory device 32; and controls the camera 22, the light sources 25, the X-axis actuator 17, the Z-axis actuator 18, the holding sensor 19, and the solenoid valve. The computer program installed in the control device 31 includes a plurality of computer programs meant for implementing a plurality of functions of the control device 31. Those functions include an illumination control unit 34, a camera control unit 35, a target recognizing unit 36, a position calculating unit 37, a holding position/holding timing calculating unit 38, and a holding control unit 39.

The illumination control unit 34 controls the light sources 25 to ensure switching on and switching off of the light sources 25. The camera control unit 35 controls the camera 22 to take an image that captures the photographic subject present within the internal space 26 of the housing 21. Moreover, the camera control unit 35 controls the memory device 32 in such a way that the data of the image taken by the camera 22 is recorded in the memory device 32 in a corresponding manner to the image capturing timing.

The target recognizing unit 36 performs image processing with respect to an image taken by the camera control unit 35, and determines whether or not any object appears in that image. If it is determined that an object appears in that image, then the target recognizing unit 36 performs further image processing with respect to that image so as to determine the material of the object and, based on the determined material, determines whether or not the object is a holding target. When the target recognizing unit 36 determines that a holding target is captured in the image taken by the camera control unit 35, the position calculating unit 37 performs further image processing and calculates the position of placement of the center of gravity of the holding target.

The holding position/holding timing calculating unit 38 calculates the holding position and the holding timing based on: the image capturing timing at which the image was taken by the camera control unit 35; the position calculated by the position calculating unit 37; and the carrier speed. The holding control unit 39 controls the X-axis actuator 17 in such a way that the suction pad 16 gets placed on the upper side of the holding position, which is calculated by the holding position/holding timing calculating unit 38, before the arrival of the holding timing, which is also calculated by the holding position/holding timing calculating unit 38. Moreover, the holding control unit 39 controls the Z-axis actuator 18 in such a way that the suction pad 16 gets placed on the upper side of the holding position, which is calculated by the holding position/holding timing calculating unit 38, at the holding timing, which is also calculated by the holding position/holding timing calculating unit 38. Furthermore, the holding control unit 39 controls the solenoid valve in such a way that the air is sucked through the opening of the suction pad 16 at the holding timing calculated by the holding position/holding timing calculating unit 38.

The operations performed in the recyclable waste auto-segregation device 2 include an operation for carrying the recyclable waste as performed by the carrier device 3, and an operation for controlling the robot unit 11 and the opto-electronic unit 12 as performed by the control device 31. In the operation for carrying the recyclable waste as performed by the carrier device 3, firstly, the user operates the carrier device 3 and activates it. As a result of the activation of the carrier device 3, the belt driving device of the carrier device 3 rotates the fixed pulleys 7 at a predetermined rotation speed. Moreover, of the belt 6, the user places a plurality of pieces of recyclable waste on the upstream side in the carrier direction 14 of the opto-electronic unit 12. Examples of the recyclable waste include plastic bottles and glass bottles. When the fixed pulleys 7 rotate at a predetermined rotation speed, the pieces of recyclable waste placed on the belt 6 are carried in a translational manner in the carrier direction 14 at a predetermined carrier speed. Due to the translation occurring in the carrier direction 14, the pieces of recyclable waste enter the internal space 26 of the housing 21 via the inlet, and move out of the internal space 26 of the housing 21 via the outlet.

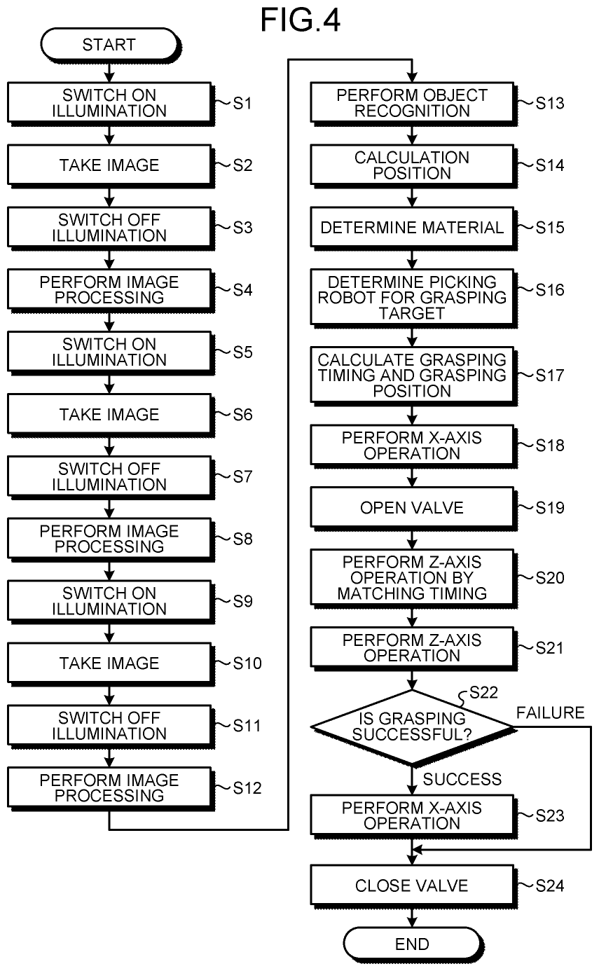

FIG. 4 is a flowchart for describing the operation performed by the control device 31 for controlling the robot unit 11 and the opto-electronic unit 12. The operation for controlling the robot unit 11 and the opto-electronic unit 12 as performed by the control device 31 is carried out in tandem with the operation for carrying the recyclable waste as performed by the carrier device 3. The control device 31 controls the light sources 25 and switches them on (Step S1). The light emitted from the light sources 25 undergoes diffused reflection from the surface of the reflecting member 24 and falls on the pieces of recyclable waste carried by the carrier device 3. Thus, in the illumination device 23, since the light emitted by the light sources 25 undergoes diffused reflection from the reflecting member 24, the light emitted from the surface light source enclosing the point of view of the image falls on the pieces of recyclable waste that have entered the internal space 26. Hence, the pieces of recyclable waste get illuminated.

When a plurality of pieces of recyclable waste is illuminated by the illumination device 23, the control device 31 controls the camera 22 to take images in which the pieces of recyclable waste are captured (Step S2). After the images are taken in which the pieces of recyclable waste are captured, the control device 31 controls the light sources 25 and switches them off (Step S3). Moreover, the control device 31 records, in the memory device 32, the images of the pieces of recyclable waste in a corresponding manner to the image capturing timings. Then, the control device 31 performs image processing with respect to the recorded images and extracts, from the images, a plurality of pictures in each of which an object is captured (Step S4).

After the elapse of a predetermined elapsed time since the completion of the operations from Step S1 to Step S4; in an identical manner to Steps S1 to S4, the control device 31 extracts, from the images of a plurality of pieces of recyclable waste, a plurality of pictures in each of which an object is captured (Steps S5 to S8). Subsequently, after the elapse of a predetermined elapsed time since the end of the operations performed from Step S5 to Step S8; in an identical manner to Steps S1 to S4, images of a plurality of pieces of recyclable waste are taken and a plurality of pictures is extracted in each of which an object is captured (Steps S9 to S12).

Based on a plurality of pictures extracted at Steps S4, S8, and S12; the control device 31 determines whether or not the object captured in each picture is a segregation target (Step S13). When a picture in which a segregation target is captured appears in a particular image, the control device 31 performs image processing with respect to that image and calculates the position of placement the center of gravity of that segregation target (Step S14). Moreover, when a picture in which a segregation target is captured appears in a particular image, the control device 31 performs image processing with respect to that image and determines the material of the segregation target (Step S15).

Based on the material determined at Step S15, the control device 31 determines the picking robot, from among a plurality of picking robots 15, to be used for holding the segregation target (Step S16). When a target picking robot is determined to be used for holding the segregation target, the control device 31 calculates the holding timing and the holding position (Step S17). The holding timing is calculated based on: the image capturing timing at which the image having the holding target appearing therein is taken; the position of placement of the center of gravity of the holding target at the calculated image capturing timing; the carrier speed; and the position in the Y-axis direction of the target picking robot. The holding timing indicates the timing at which the holding target passes through the motion range of the suction pad 16 of the target picking robot. The holding position indicates the position of placement of the center of gravity of the holding target at the holding timing, that is, indicates that position in the motion range of the suction pad 16 of the target picking robot through which the holding target passes.

The control device 31 controls the X-axis actuator 17 of the target picking robot and places the suction pad 16 of the target picking robot at a holding preparation position (Step S18). The holding preparation position is present on the upper side of the holding position; and the X-axis position in the X-axis direction of the holding preparation position is equal to the X-axis position in the X-axis direction of the holding position. That is, the pictorial figure obtained as a result of orthogonal projection of the suction pad 16, which is placed at the holding preparation position, onto the X-axis overlaps with the pictorial figure obtained as a result of orthogonal projection of the holding target, which is placed at the holding position, onto the X-axis. After the suction pad 16 is placed at the holding preparation position, the control device 31 controls the solenoid valve so that the suction pad 16 is connected to the suction pump and the air is sucked through the opening of the suction pad 16 (Step S19).

The control device 31 controls the Z-axis actuator 18 of the target picking robot and places the opening of the suction pad 16 of the target picking robot at the holding position at the holding timing (Step S20). When the opening of the suction pad 16 gets placed at the holding position at the holding timing, the suction pad 16 makes contact with the holding target. When the holding target comes in contact with the opening of the suction pad 16, since the air has already been sucked through the opening of the suction pad 16, the holding target gets held by the suction pad 16. After the suction pad 16 is placed at the holding position, the control device 31 controls the Z-axis actuator 18 and places the suction pad 16 at the holding preparation position (Step S21). As a result of placing the suction pad 16 at the holding preparation position, the holding target gets lifted up from the belt 6.

When the suction pad 16 is placed at the holding preparation position, the control device 31 controls the holding sensor 19 of the target picking robot and determines whether or not the holding target is appropriately held by the suction pad 16 (Step S22). If the holding target is appropriately held by the suction pad 16 (Success at Step S22), then the control device 31 controls the X-axis actuator 17 and places the suction pad 16 at an initial position that is on the upper side of the dumping case of the target picking robot (Step S23).

After the suction pad 16 is placed at the initial position, the control device 31 controls the solenoid valve and terminates the connection between the suction pad 16 and the suction pump, so that there is no suction of the air through the opening of the suction pad 16 (Step S24). As a result of ensuring that there is no suction of the air through the opening of the suction pad 16, the holding target that is held by the suction pad 16 gets released from the suction pad 16 and falls down into the dumping case of the target picking robot. On the other hand, if the holding target is not appropriately held by the suction pad 16 (Failure at Step S22), then the control device 31 controls the solenoid valve and closes it, so that there is no suction of the air through the opening of the suction pad 16 (Step S24). Meanwhile, if a plurality of holding targets is captured in a taken image, then the control device 31 performs the operations from Step S18 to Step S24 in a repeated manner.

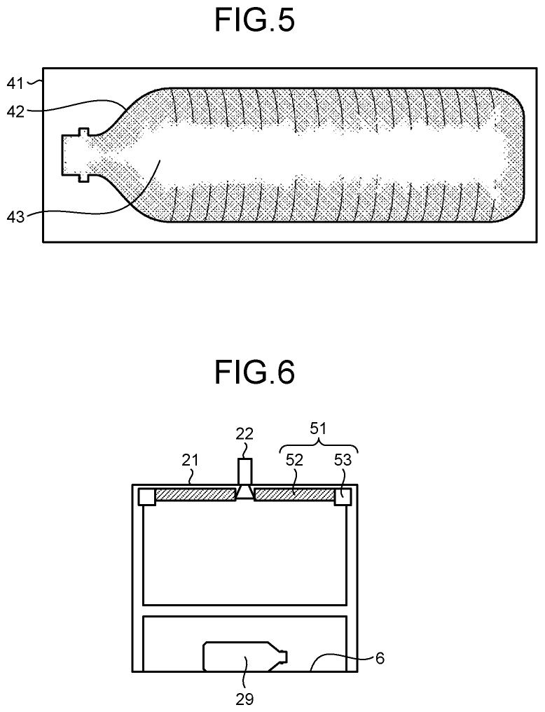

FIG. 5 is a diagram illustrating an image 41 of a photographic subject 29 as captured by the camera 22. The image 41 includes a picture 42 of the photographic subject 29. The picture 42 has an overexposed region 43 in which overexposure has occurred and which is entirely filled with white color. That is, in each pixel included in the overexposed region 43, the red gradation value, the green gradation value, and the blue gradation value indicate the upper limit value. Such overexposure occurs when the photographic subject 29 has a glossy surface and the light emitted onto the photographic subject 29 from the illumination device 23 undergoes specular reflection from the surface of the photographic subject 29.

When the light emitted from the surface light source of the illumination device 23 falls on the photographic subject 29, the proportion of the dimension of the overexposed region 43 with respect to the dimension of the picture 42 is greater than a predetermined value. That is, the reflecting member 24 of the illumination device 23 is formed in such a way that the proportion of the dimension of the overexposed region 43 with respect to the dimension of the picture 42 becomes greater than a predetermined value. Moreover, the light sources 25 of the illumination device 23 are set in such a way that the amount of light emitted from the light sources 25 becomes greater than a predetermined value so as to ensure that the overexposed region 43 is included in the picture 42.

In the picture 42, there are times when distracting images appear that obstruct the extraction of the picture 42 from the image 41. For example, if the photographic subject 29 has a film pasted onto its surface or has an image such as characters, an illustration, or a photograph printed onto its surface, then there are times when that picture appears in the picture 42. Moreover, if the photographic subject 29 is made of a light transmissive material, then the background behind the photographic subject 29 appears in the picture 42 due to the light passing through the photographic subject 29. Examples of the light transmissive material include polyethylene terephthalate (PET) and glass. When a distracting picture appears in the picture 42, the control device 31 may mistakenly extract the picture of the background as the picture 42 capturing the photographic subject 29. If the picture of the photographic subject 29 is incorrectly extracted from the image 41, then sometimes the control device 31 cannot appropriately calculate the position of placement of the center of gravity of the photographic subject 29. In the object processing apparatus 1, when the position of placement of the center of gravity of the photographic subject 29 is not appropriately calculated, there are times when the photographic subject 29 is not appropriately held.

As a result of having a large proportion of the dimension of the overexposed region 43 with respect to the dimension of the picture 42, the control device 31 becomes able to relatively reduce the proportion of the dimension of the distracting picture with respect to the dimension of the picture 42. When the dimension of the distracting picture is small, the control device 31 becomes able to enhance the probability of appropriately extracting the picture 42 from the image 41, and hence can prevent false recognition of the position of the photographic subject 29. In the object processing apparatus 1, as a result appropriately calculating the position of the photographic subject 29, it becomes possible to appropriately hold the photographic subject 29 and hence to appropriately segregate the photographic subject 29.

[Effects of Object Recognition Device 10 According to First Embodiment]

The object recognition device 10 according to the first embodiment includes the illumination device 23 and the camera 22. The illumination device 23 emits a light from the surface light source onto the photographic subject 29 and thus illuminates the photographic subject 29. The camera 22 takes the image 41 of the photographic subject 29 in such a way that overexposure occurs in the picture 42 in which the photographic subject 29 appears. The position calculating unit 37 performs image processing with respect to the image 41 and calculates the position of placement of the photographic subject 29.

In the object recognition device 10 according to the first embodiment, because of the overexposure occurring in the picture 42 in which the photographic subject 29 appears, any graphical content printed on the surface of the photographic subject can be prevented from appearing in the picture 42, and the background visible due to the light passing through the photographic subject 29 can be prevented from appearing in the picture 42. In the object recognition device 10 according to the first embodiment, distracting pictures can be prevented from appearing in the picture 42, thereby enabling appropriate extraction of the picture 42 of the photographic subject 29 from the image 41 in which the photographic subject 29 is captured. In the object recognition device 10 according to the first embodiment, as a result of appropriate extraction of the picture 42 of the photographic subject 29 from the image 41 in which the photographic subject 29 is captured, the position of placement of the photographic subject 29 can be appropriately calculated based on the image 41.

The object processing apparatus 1 according to the first embodiment includes the object recognition device 10, the suction pad 16, the X-axis actuator 17, the Z-axis actuator 18, and the holding control unit 39. The X-axis actuator 17 and the Z-axis actuator 18 move the suction pad 16. The holding control unit 39 controls the X-axis actuator 17 and the Z-axis actuator 18 based on the position calculated by the position calculating unit 37, so that the suction pad 16 holds the photographic subject 29. In the object processing apparatus 1 according to the first embodiment, since the object recognition device 10 appropriately calculates the position of the photographic subject 29, it becomes possible to appropriately hold the photographic subject 29, and to appropriately segregate a plurality of pieces of recyclable waste.

Moreover, in the object processing apparatus 1 according to the embodiment, the photographic subject 29 is carried by the carrier device 3. The holding control unit 39 controls the X-axis actuator 17 and the Z-axis actuator 18 in such a way that the suction pad 16 holds the photographic subject 29 at the holding timing calculated based on the image capturing timing at which the image 41 was taken. In the object processing apparatus 1 according to the first embodiment, even when the photographic subject 29 is being carried, the holding timing, at which the photographic subject 29 passes through the motion range of the suction pad 16, can be appropriately calculated based on the image capturing timing at which the image 41 was taken. Thus, in the object processing apparatus 1 according to the first embodiment, as a result of appropriately calculating the holding timing, the photographic subject 29 can be appropriately held, and a plurality of pieces of recyclable waste can be appropriately segregated.

Moreover, in the object recognition device 10 according to the first embodiment, the illumination device 23 includes the reflecting member 24 that encloses the point of view of the image 41; and includes a plurality of light sources 25 that emit a light onto the reflecting member 24. The illumination device 23 projects, onto the photographic subject 29, the light that has undergone diffused reflection from the reflecting member 24. That is, the illumination device 23 is based on the principle of indirect illumination. In the object recognition device 10, since the illumination device 23 is based on the principle of indirect illumination, the surface light source meant for illuminating the photographic subject 29 can be appropriately manufactured, and overexposure can be appropriately generated in the picture 42 of the photographic subject 29.

Meanwhile, in the object recognition device 10 according to the first embodiment, the illumination device 23 illuminates the photographic subject 29 using the surface light source made of the entire inside surface of the housing 21. Alternatively, another type illumination device can be used that illuminates the photographic subject 29 using a surface light source made of only some part of the inside surface of the housing 21.

### Second Embodiment

As illustrated in FIG. 6, in an object recognition device according to a second embodiment, the illumination device 23 of the object recognition device 10 according to the first embodiment is substituted with an illumination device 51. Apart from that, the configuration is identical to the object recognition device 10 according to the first embodiment. FIG. 6 is a cross-sectional view of the illumination device 51 of the object recognition device according to the second embodiment. The illumination device 51 includes a light guide plate 52 and a plurality of light sources 53. The light guide plate 52 is formed in a flat plate-like shape. The light guide plate 52 covers the ceiling surface facing the belt 6 in the housing 21; and is placed to enclose the camera 22, that is, is placed to enclose the point of view of the image taken by the camera 22. The light sources 53 are placed on the edges of the light guide plate 52 and emit a light onto the end faces of the light guide plate. The light emitted onto the end faces of the light guide plate 52 spreads on the inside portion thereof, and diffuses roughly uniformly on that surface of the light guide plate 52 which faces the belt 6. That is, in the illumination device 51, since the light emitted onto the end faces of the light guide plate 52 diffuses on the surface of the light guide plate 52, the photographic subject gets illuminated from the surface light source that encloses the point of view of the camera 22.

In the object recognition device according to the second embodiment, even in the case of using the illumination device 51, the photographic subject can be illuminated from the surface light source. Thus, in an identical manner to the object recognition device 10 according to the first embodiment, an image of the photographic subject can be taken in such a way that overexposure occurs in the picture in which the photographic subject appears. In the object recognition device according to the second embodiment, because of the occurrence of overexposure in the picture in which the photographic subject appears, in an identical manner to the object recognition device 10 according to the first embodiment, distracting pictures can be prevented from appearing in the picture of the photographic subject, and the picture of the photographic subject can be appropriately extracted from the image in which the photographic subject is captured. Thus, in the object recognition device according to the second embodiment, since the picture of the photographic subject can be appropriately extracted from an image, the position of the photographic subject can be appropriately calculated by performing image processing with respect to the image.

### Third Embodiment

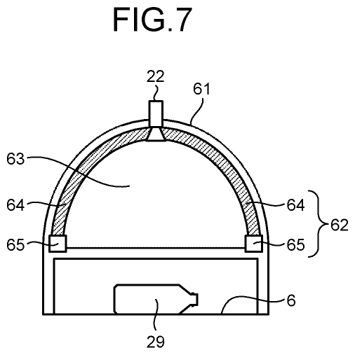

As illustrated in FIG. 7, in an object recognition device according to a third embodiment, the housing 21 and the illumination device 23 of the object recognition device 10 according to the first embodiment are substituted with a domed housing 61 and an illumination device 62, respectively. FIG. 7 is a cross-sectional view of the domed housing 61 and the illumination device 62 of the object recognition device according to the third embodiment. The domed housing 61 is formed in a semispherical shape and, except for having a different shape than the housing 21, functions in an identical manner to the housing 21. Moreover, the domed housing 61 has an internal space 63 formed therein.

The illumination device 62 includes a reflecting member 64 and a plurality of light sources 65. The reflecting member 64 covers roughly the entire inside surface that faces the internal space 63 of the domed housing 61; and is placed to enclose the camera 22, that is, is placed to enclose the point of view of the image taken by the camera 22. The reflecting member 64 causes diffused reflection of the light falling thereon. The light sources 65 are placed on the inside of the domed housing 61 and on the lower side close to the belt 6. The light sources 65 emit a light onto the reflecting member 64.

In the object recognition device according to the third embodiment, even in the case of using the illumination device 62, the photographic subject can be illuminated from the surface light source. Thus, in an identical manner to the object recognition device 10 according to the first embodiment, an image of the photographic subject can be taken in such a way that overexposure occurs in the picture in which the photographic subject appears. In the object recognition device according to the third embodiment, because of the occurrence of overexposure in the picture in which the photographic subject appears, in an identical manner to the object recognition device 10 according to the first embodiment, distracting pictures can be prevented from appearing in the picture of the photographic subject, and the picture of the photographic subject can be appropriately extracted from the image in which the photographic subject is captured. Thus, in the object recognition device according to the third embodiment, since the picture of the photographic subject can be appropriately extracted from an image, the position of the photographic subject can be appropriately calculated by performing image processing with respect to the image.

Meanwhile, each of the illumination devices 23, 51, and 62 can be substituted with some other type of illumination device that illuminates the photographic subject using the light emitted from the surface light source. Examples of such other illumination device includes an illumination device having frosted glass. That illumination device includes a light source and frosted glass. The light source is placed to emit a light toward the photographic subject. The frosted glass is placed in between the light source and the photographic subject and encloses the camera 22. The light emitted from the light source falls on the frosted glass; passes through the frosted glass; is scattered by the frosted glass; diffuses due to the frosted glass; and falls on the photographic subject roughly uniformly from the frosted glass. That is, the illumination device can illuminate the photographic subject from the surface light source. In an object recognition device including such an illumination device, in an identical manner to the object recognition device 10 according to the first embodiment, an image of the photographic subject can be taken in such a way that overexposure occurs in the picture in which the photographic subject appears.

Meanwhile, the illumination device of the object recognition device according to any of the embodiments described above emits a light onto the photographic subject from the surface light source that encloses the camera 22. However, it is alternatively possible to use an illumination device that emits a light onto the photographic subject from the surface light source that does not enclose the camera 22. Even in the case of using an object recognition device in which such an illumination device is used, in an identical manner to the object recognition device 10 according to the first embodiment, an image of the photographic subject can be taken in such a way that overexposure occurs in the picture in which the photographic subject appears.

Even when any of the abovementioned illumination devices is used in the object recognition device 10, the position of the photographic subject can be appropriately calculated, so that the photographic subject can be appropriately held and the recyclable waste can be appropriately segregated.

In the object recognition device 10 according to the first embodiment, the amount of light emitted onto the photographic subject 29 is set in such a way that overexposure occurs in the image 41. Thus, in the object recognition device 10, as a result of setting a large amount of light emitted onto the photographic subject 29, it is possible to appropriately cause overexposure in the picture 42 of the photographic subject 29, without having to adjust the settings of the camera 22.

In the object recognition device 10 according to the first embodiment, the amount of light emitted from the illumination device 23 onto the photographic subject 29 is set to be large so as to cause overexposure in the picture of the photographic subject. However, alternatively, overexposure in the picture of the photographic subject can be caused using some other setting. For example, in the object recognition device 10, the exposure of the camera 22 can be corrected so as to cause overexposure in the picture of the photographic subject. Alternatively, in the object recognition device 10, image processing can be performed with respect to the image of the photographic subject so as to cause overexposure in the picture of the photographic subject. For example, the control device 31 processes an image taken by the camera 22, searches for pixels whose brightness exceeds the threshold value from the image, and replaces the pixels with other pixels indicating an upper limit value of gradation value. At this time, the object recognition device 10 can generate another image in which overexposure occurs. In the object recognition device 10, even if overexposure in the picture of the photographic subject is caused in any such way, the picture of the photographic subject can be appropriately extracted from the image of the photographic subject.

The suction pad 16 described above may be replaced with a remover that removes the holding object from the carrier device 3 without holding the holding target. For example, the remover pushes the holding target out of the carrier device 3, flicks the holding target away from the carrier device 3, or blows air on the holding target to blow the holding target away from the carrier device 3.

The object recognition device and the object processing apparatus disclosed herein enable appropriate detection of a picture of an object from an image in which the object is captured.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the disclosure have been described in detail, it should be understood that the various changes, substitutions, and alterations could be made hereto without departing from the spirit and scope of the disclosure.

What is claimed is:

1. An object recognition device comprising:
an illuminator configured to illuminate an object;
an imager configured to generate an image of the object such that overexposure occurs in the image; and
circuitry configured to calculate a position of the object based on the image.

2. The object recognition device according to claim 1, wherein the object is light transmittable.

3. The object recognition device according to claim 1, wherein the illuminator includes:
a reflector configured to cover the object; and
a light source configured to emit a light onto the reflector such that a light diffusely reflected by the reflector is projected onto the object.

4. The object recognition device according to claim 1, wherein the illuminator includes:
a light guide plate configured to cover the object; and
a light source configured to emit a light onto edge of the light guide plate such that a light passed through the light guide plate is projected onto the object.

5. The object recognition device according to claim 1, wherein the illuminator includes:
a frosted glass configured to cover the object; and
a light source configured to emit a light onto the frosted glass such that a light diffused by the frosted glass is projected onto the object.

6. The object recognition device according to claim 1, wherein the illuminator emits an amount of light at which overexposure occurs in the image of the object.

7. The object recognition device according to claim 1, wherein exposure amount of the imager is the amount at which overexposure occurs in the image of the object.

8. The object recognition device according to claim 1, wherein the imager processes another image taken by a camera to generate the image based on the other image.

9. An object processing apparatus comprising:
a remover configured to remove an object;
a driver configured to move the remover;
an illuminator configured to illuminate the object;
an imager configured to take an image of the object such that overexposure occurs in the image; and
circuitry configured to calculate a position of the object based on the image and control the driver based on the position such that the remover removes the object.

10. The object processing apparatus according to claim 9, further comprising a conveyor, wherein
when the object is carried by the conveyor, the circuitry controls the driver such that the remover removes the object from the conveyor at a timing that is calculated based on a timing at which the image was taken.
